(19) United States
(12) Patent Application Publication
(10) Pub. No.: US 2022/0362822 A1
(43) Pub. Date: Nov. 17, 2022

(54) System and Method for Sequestering Carbon Dioxide Using Biopolymers

(71) Applicants: Eugenio Giraldo, Robbinsville, NJ (US); Nicolas Enrique Giraldo-Wingler, Robbinsville, NJ (US); Ana Cecilia Giraldo-Wingler, Robbinsville, NJ (US); Gabriel Howard Giraldo-Wingler, Robbinsville, NJ (US); Barbara Jean Wingler, Robbinsville, NJ (US)

(72) Inventors: Eugenio Giraldo, Robbinsville, NJ (US); Nicolas Enrique Giraldo-Wingler, Robbinsville, NJ (US); Ana Cecilia Giraldo-Wingler, Robbinsville, NJ (US); Gabriel Howard Giraldo-Wingler, Robbinsville, NJ (US); Barbara Jean Wingler, Robbinsville, NJ (US)

(21) Appl. No.: 17/322,732

(22) Filed: May 17, 2021

(51) Int. Cl. B09B 5/00; B29B 17/00; G06Q 30/00; G06Q 30/02

(52) U.S. Cl. CPC B09B 5/00; B29B 17/00; G06Q 30/018; G06Q 30/0208; B29B 2017/001

(57) ABSTRACT

Systems and methods for sequestering carbon dioxide from the environment using biopolymers are disclosed. The methods include forming consumer products using bioplastics or biopolymers, collecting said consumer products after consumer use and stopping biodegradation of said biopolymer. In some embodiments the biopolymer is a non-biodegradable biopolymer while in other embodiments the degradation of the biopolymer is stopped by alternative means. A tracking system of the fate of the bioplastic or biopolymer during the lifecycle of the product is described.

### CROSS-REFERENCE TO RELATED APPLICATIONS

This application claims priority to U.S. Provisional Patent Application No. 63/027,299 titled “Method for Sequestering Carbon Dioxide Using Biopolymers” filed May 19, 2020, the entire disclosure of which is herein incorporated by reference in its entirety for all purposes.

### FIELD OF THE TECHNOLOGY

Aspects and embodiments disclosed herein relate to systems and methods for sequestering carbon dioxide from the atmosphere by means of bioplastics and biopolymers.

### SUMMARY

In accordance with one aspect, a method is provided for sequestering carbon dioxide from the atmosphere by making consumer products from a biopolymer, collecting said consumer product after consumer use and managing the consumer product after collection in such a way that the carbon in the biopolymer remains in the product and does not escape back as a gas to the atmosphere. A system and a method for tracking the fate of the biopolymer during its lifecycle are provided.

### BACKGROUND

Climate change is fueled by the accumulation of greenhouse gases in the atmosphere, such as carbon dioxide, which induce global warming. The predicted impacts of climate change are catastrophic. The worst impacts are expected to occur when the average atmospheric temperature in the world increases by 1.5° C. more compared to pre-industrial levels. Alarmingly, atmospheric temperatures have already increased by 1.1° C. and an increase of 1.5° C. is possible by 2030. There is an urgent, timely need for novel carbon sequestration technologies to lower levels of greenhouse gases in order to mitigate climate change. Capturing carbon dioxide by producing biomass is one way of sequestering carbon from the atmosphere—binding the carbon present in the carbon dioxide molecules in a structure that keeps the carbon from re-entering its gaseous, heat-trapping form. The problem with this, however, is that subsequent degradation of the produced biomass releases the carbon back into gaseous forms such as methane or carbon dioxide that enter the atmosphere and induce further heat trapping effects. Minimizing degradation of biomass would be a form of sequestering such carbon in the biomass and thus contributing to a reduction in greenhouse gas emissions.

Plastics are mostly (99%) produced from petroleum, and about 2-4 lb of CO₂ equivalents are emitted to the environment during manufacturing for every lb of plastic produced. An estimated total of 360 Million tonnes of plastics are produced annually with 26% being used for packaging. Plastic packaging presents further environmental challenges because a significant portion of it ends up in the oceans, with an estimated 150 Million tonnes of plastics currently residing in the oceanic environment. The estimated environmental damage of plastic packaging far exceeds the profits of the plastic packaging industry. Despite this, only 3% of plastics are recycled in the United States, partially due to difficulties in recycling plastic packaging. The reasons for poor recycling rates of plastic packaging are numerous. First, packaging plastic films are not compatible with existing separation and sorting technologies in material recycling facilities, MRFs, to the point that most MRFs do not accept plastic packaging materials. Second, the cost of recycled resin produced from packaging plastics is more expensive than the cost of virgin resin, making a poor economic case for its use. Third, the quality of the recycle resin is inconsistent, and plastic packaging extrusion processes require a high quality resin. Finally, there are limitations in the use of recycled plastic for food—packaging applications due to FDA requirements regarding the quality of the resin, thus limiting the application of the resin to products not in contact with food.

One way of improving the environmental footprint of plastics is to substitute fossil plastics (plastics derived from petroleum) with bioplastics, or biopolymers, (plastics derived from biomass). Current art for the use of biopolymers for environmental benefits focuses on the biodegradation characteristics of the biopolymer for zero waste industrial programs and to conform to the directives of the circular economy initiatives. There are over 36,000 patents granted and applications on biodegradable polymers and plastics and over 25,000 on compostable plastics. However, in this particular case, the objectives of the circular economy which focus on biodegradable bioplastics are in conflict with the urgent need to enhance carbon capture initiatives as previously described. All emphasis in bioplastics is currently associated with programs around the circular economy where biodegradation of plastics is a central and essential aspect of the process. There are clear benefits in the avoidance of accumulation of plastics in the ocean if the plastic is biodegradable and will not persist in the oceanic environment; however, release of carbon dioxide and methane back to the environment occurs as a consequence.

Comparison of life cycle analyses of the production of fossil plastics and bioplastics shows that when carbon capture into the chemical structure of the bioplastic itself is taken into account as a carbon credit, the greenhouse gas emissions from cradle to gate (emissions accounted for to the gate of the factory) are significantly better for bioplastics than for fossil plastics. However, when bioplastics are then biodegraded after use in composting operations or in landfills for example, the carbon captured in the plastic is broken down and released as a mixture of carbon dioxide and methane gases in both cases. Not only are the carbon credits that were gained by the sequestration of carbon into biomass lost during degradation, there is actually a net increase in carbon emissions to the extent that the lifecycle greenhouse gas emissions of bioplastics are now similar and in some cases even higher than those of fossil plastics. On the other hand, non-biodegradable bioplastics if collected and properly disposed do not release gases to the atmosphere.

The present invention defines several means by which the greenhouse gas footprint of bioplastics, and more generally of biopolymers, such as plastics and wood, can be reduced by impeding or slowing the biodegradation of said biopolymers. In addition, the present invention includes the establishment of identification and tracking processes that uses a computer-based system to track and report on the path of bioplastic products from cradle to grave (synthesis to final disposal). The identification and tracking processes include consumer interaction to encourage consumers to dispose of the biomaterial products at specified collection sites. Consumer participation is essential to satisfy two purposes—first, to ensure the carbon sequestering objectives are met and second, to avoid of accumulation of plastic products in environments in which they may cause nuisance or ecological harm. The tracking mechanism also enables the calculation and display of specific environmental metrics of the use of biomaterials such as but not limited to carbon footprint, or energy footprint, or material collection efficiency.

A schematic of the processes for sequestering carbon in biopolymers is presented in FIG. 1. The life cycle of a biopolymer from cradle to grave is presented. Carbon dioxide and energy are combined in a biologically-mediated process, such as photosynthesis or an autotrophic microbial-mediated conversion, such as but not limited to methanogenesis from carbon dioxide and hydrogen, to produce biomass. The biological process can occur in a living organism, such as but not limited to a corn plant or a soybean plant or sugar cane plant, and yet in other cases can occur in single cell living organisms such as algae or bacteria or archaea. In the latter case, when the organisms are unicellular, the carbon dioxide might be dissolved in water and the energy source might be a chemical compound, such as but not limited to molecular hydrogen. Carbon dioxide is incorporated into the chemical species that comprise the produced biomass which is then collected and transformed through an industrial process into biomaterials such as, but not limited to: biopolymers, cellulose, bioplastics or wood. An example of such industrial process for the conversion of biomass into biopolymers is the conversion of corn into Polylactic acid, PLA, polymer by the Minnesota-based company Natureworks, which is the largest manufacturer of bioplastics in the United States. Many other biopolymers are currently produced and commercialized, such as but not limited to, biopolyethylene, bioPE from sugarcane, polyhydroxybutyrate, PHB, from corn, or thermo plastic starch, TPS, also from corn or potato, being the most common. In some cases the biomaterials are fully degradable, such as PLA, while in other cases the biomaterials are non-biodegradable, such as polyethylene. Further processing of the biopolymer is conducted to manufacture consumer products such as but not limited to: packaging plastics for food, medicines, beverages, personal care, consumer shopping bags and wrapping films, or plastic films used in agriculture with the purpose of weed suppression, and moisture and heat control in the soil. During that manufacturing process a previously biodegradable biomaterial can be rendered non-biodegradable by adding a special ingredient or encapsulating the biomaterial to avoid degradation. In the latter case, encapsulation creates an environment that is not conducive to biodegradation. Yet in other cases the previously biodegradable biomaterial can be rendered non-biodegradable by blending said biomaterial with an ingredient making the blend non-biodegradable; an example of such process is the blend of PLA with different polymers such as Polyethylene glycol (PEG) or lignin or a mixture of polycaprolactone and chitosan.

### BRIEF DESCRIPTION OF THE DRAWINGS

The accompanying drawings are not intended to be drawn to scale. For purposes of clarity, not every component may be labeled in every drawing. In the drawings:

FIG. 1 is a block diagram illustrating the capture of carbon dioxide from the environment to form a biopolymer and the fate of the biopolymer as is transformed into a consumer product;

FIG. 2 is a bar graph that illustrates the net greenhouse gas emissions of common plastics and bioplastics for different fates in the environment;

FIG. 3 is a block diagram illustrating the structure of an exemplary tracking system;

FIG. 4A, FIG. 4B, FIG. 4C, FIG. 5A, FIG. 5B, FIG. 5C, FIG. 6A, FIG. 6B, FIG. 6C, and FIG. 7 are illustrations of the screens designs of an exemplary application program for a mobile phone used to interact with the tracking system by a user of the carbon capture system.

### DETAILED DESCRIPTION

The subject matter of embodiments of the present invention is described with specificity herein to meet statutory requirements; however, the description itself is not intended to necessarily limit the scope of claims. Rather, the claimed subject matter might be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described.

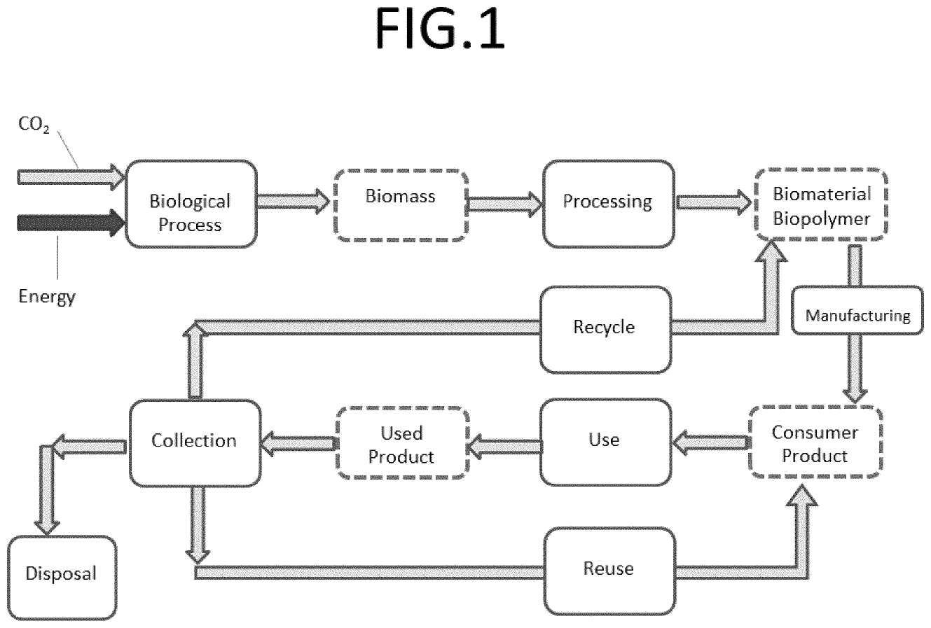

FIG. 1 further illustrates the use of the consumer product and its discarding by the consumer to become a “used” product. The used product is collected and can be managed after collection to follow one of several paths; in one case it can be reused and returned back to the consumer for additional use, in another case it can be recycled by processing it back into a biopolymer, or a biomaterial, that can be further converted into a consumer product again, or in a further case it can go to final disposal after final consumer use. The tracking mechanism in this invention includes tracking the fate of the material in the product in one or several cycles or reuse and recycle of the product. The consumer product can be rendered non-biodegradable during several of the processing steps in the lifecycle. For example, one option is to synthesize a non-biodegradable polymer such as bio-polyethylene. A second alternative is to combine the biopolymer during the consumer product manufacturing stage with an ingredient that impedes or significantly slows the biodegradation process. From the point of view of the impact of greenhouse gases to global warming, the established protocol of the United Nations uses a 100-year time frame to evaluate the impact of greenhouse gases on climate change. For the purpose of this invention stopping biodegradation of a biodegradable polymer is understood as slowing the rate of degradation in such a way that 50% to 100%, or 60% to 100%, or 70% to 100%, or 80% to 100% of the carbon originally present in the biopolymer chemical structure remains after 100 years.

Stopping or slowing biodegradation could include a process, such as but not limited to, combining wood fibers or cellulose paper fibers with a non-biodegradable plastic to make a plastic composite such as but not limited to a lumber resin, or applying a coating of a non-biodegradable material to the biopolymer to impede the ingress of moisture and enzymes to the biopolymer thus creating an environment not conducive to biodegradation. Similarly, during the recycle process, the biopolymer can be combined with an ingredient to make the recycled biopolymer non-biodegradable, such as, but not limited to combining paper cellulose fibers with a non-biodegradable plastic, and then using the fibers as filler in the plastic resin formulation. The fibers are encapsulated within the plastic matrix, thus rendering said fibers inaccessible and creating an environment not conducive to biodegradation. Yet another example is the combination of PLA with LDPE (low density polyethylene) resin to make a non-biodegradable recycled mixed resin for use in consumer product manufacture. Similarly, used or reclaimed wood could be combined with non-biodegradable plastic resin to produce plastic lumber resin for use in the manufacture of consumer products. A third alternative would be to dispose of the biopolymer in an environment where biodegradation is slowed or stopped due to the fact that the conditions of the environment are such that the rate of degradation is reduced to less than 20% in 100 years. For example, this concept would apply to PLA stored in conditions of a relatively dry atmosphere at a temperature below 50° C., such as in a landfill cell devoid of food waste or a dry sealed container where ingress of water is avoided.

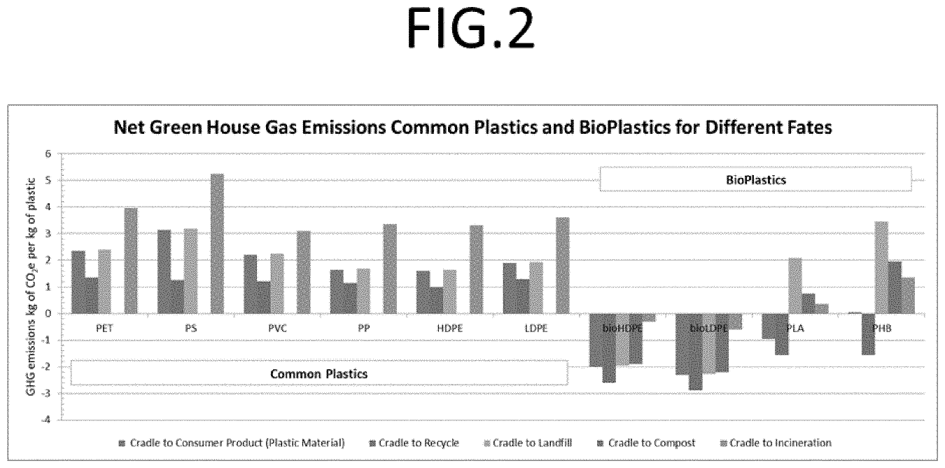

The greenhouse gas sequestering benefits of the proposed method using bioplastics as an example is illustrated in FIG. 2. The data represented in this figure was derived from Possen et al (2016) and Krause and Townsend (2016) which thoroughly review the greenhouse gas emission of plastics. FIG. 2 illustrates that all the common plastics—PET, PS, PVC, PP, HDPE, LDPE— which are fossil plastics derived from petroleum, have high greenhouse gas emissions regardless of final disposal. The worst final disposal option of a common plastic, from the point of view of greenhouse gas emission, is incineration because it releases fixed carbon dioxide to the atmosphere. The savings from energy recovery in incineration facilities are not enough to offset the amount of carbon released; as a consequence a net greenhouse gas contribution is incurred during incineration. For bioplastics that are non-biodegradable such as bioethylene based plastics, bioHDPE or bioLDPE, there is always a net sequestering effect on CO₂, even in the case of incineration. The best final disposal option across the board is recycling, followed by landfilling, while the worst option is again incineration as it releases carbon dioxide to the atmosphere that was effectively sequestered within the plastic. For biodegradable bioplastics, the benefits of sequestering are negated and they become net greenhouse gas contributors when the plastic is degraded either via compost or in a landfill. In composting the vast majority, 95%, of the carbon ends up as carbon dioxide and the remaining portion as methane due to the aerobic degradation conditions. The impact of landfilling is larger than that of composting because degradation in the anaerobic conditions of a landfill releases mainly methane gas that is 25 times more potent as a greenhouse gas than the carbon dioxide. In either composting or landfilling, however, bioplastics would become net contributors to greenhouse gas emissions. In the short term, given the urgent need to sequester carbon in a timely manner, a better alternative to biodegradable bioplastics is to stop biodegradation of biopolymers, cellulose, wood, bioplastics and others and sequester the carbon within, to prevent it from entering the atmosphere.

The present invention incorporates a tracking system for the biopolymer in order to guarantee that the carbon locked within the biopolymers remains as part of the chemical structure of the product, and that it is not released back to the atmosphere in gaseous forms. The tracking system proposed in this application would employ a combination of hardware, software, and manufacturing techniques to track each individual biopolymer product and more specifically the biopolymer therein through its entire lifecycle-through disposal and potential reuse and repurposing to its final, approved resting place. Such a tracking system would serve to ensure transparency across all stages in a product's lifecycle, and most importantly would enable quantification of the emissions and pollution caused by said product, thus allowing companies to be more accountable regarding the environmental impact caused by their plastic consumption. The transparency and accountability generated by the system would allow environmentally-conscious consumers to make safe, informed decisions regarding their purchases, and would also allow companies to more easily take advantage of any government incentives regarding carbon emissions.

For example, such a tracking system could be used in a restaurant setting to allow for guilt-free use of plastic straws: The restaurant would purchase specially-designed straws made from non-biodegradable bioplastic. A custom receptacle designed to accommodate a set amount of straws would be provided for the customers or employees of the restaurant to place the straws in when they are consumed. Each plastic container when full would have a unique identifier, unique ID, generated for all the plastic contained within, which would then be also associated with any products made from said plastic if recycled. The unique ID system could be implemented through the use of a technology such as blockchain, which would also make falsification of records impossible.

All data related to the current state of any plastic entered into the system would be stored in a database, where it could be made available to the client, company, consumers and regulatory agencies as needed and/or desired, in forms such as but not limited to mobile applications, web dashboards, and desktop software. The data would allow for the calculation and display of various metrics, such as reduction in carbon emissions attributed to the use of non-biodegradable bioplastic, quantity of ecological plastic pollution avoided, recycled products made from the plastic, etc. This information would serve as a product in itself, empowering both industry and consumers to make better and more informed decisions.

The tracking system could be expanded to account for many different types of products, as the benefits of the system increase as more products are tracked. For example, Quick Response (QR) codes, or bar codes, could be printed on plastic products directly or on stickers affixed to said products. Examples of such products would be film packaging, plastic cups, bottles, food containers, straws, utensils, and shipping containers. The QR codes, or bar codes, would be associated with the unique identifier for the plastic. By scanning the code with a smartphone or other suitable device, the status of the product would be updated in the database.

For consumer products, collection sites would be required, to ensure that the plastic remains within the system. These collection sites could be made up of participating businesses, consumer's homes, or dedicated locations. Scanning of the QR codes, or bar codes, or equivalent, and thus updating the database would be performed by the consumers themselves, or employees at a collection site. Further validation would be implemented by weighing the plastic upon collection. Incentives for consumers to scan the codes themselves could come in the form of discounts or rewards from participating client companies, as well as instant access to data.

For products designed to remain within a clients' home and used for an extended amount of time, the consumers themselves would be required to update the status of the product when prompted, after a recurring, pre-determined period. Consumers would be rewarded with every update, with greater rewards offered for every successive update. Products not updated within a certain timeframe within the database would be marked as “lost” within the database and treated as removed from the tracking system.

Once returned, the plastics would be either recycled into new products, or placed in a permanent retention facility, where they would be marked as “locked” within the system. “Locked” plastic would contribute to reduction in carbon emissions, as the biologically-derived carbon present within the plastic itself or any materials encapsulated by said plastic would not enter the atmosphere in the form of carbon dioxide.

### EXAMPLES

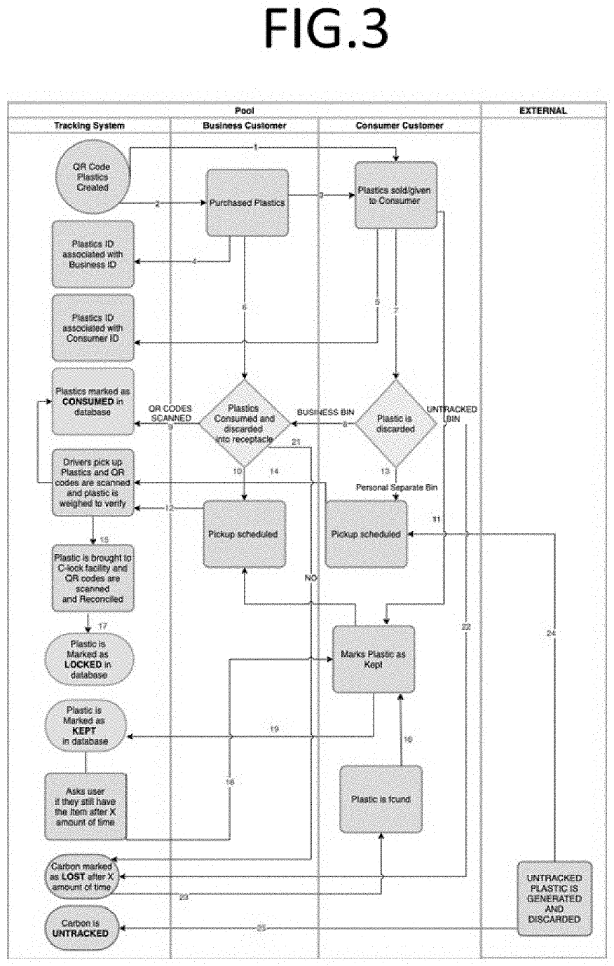

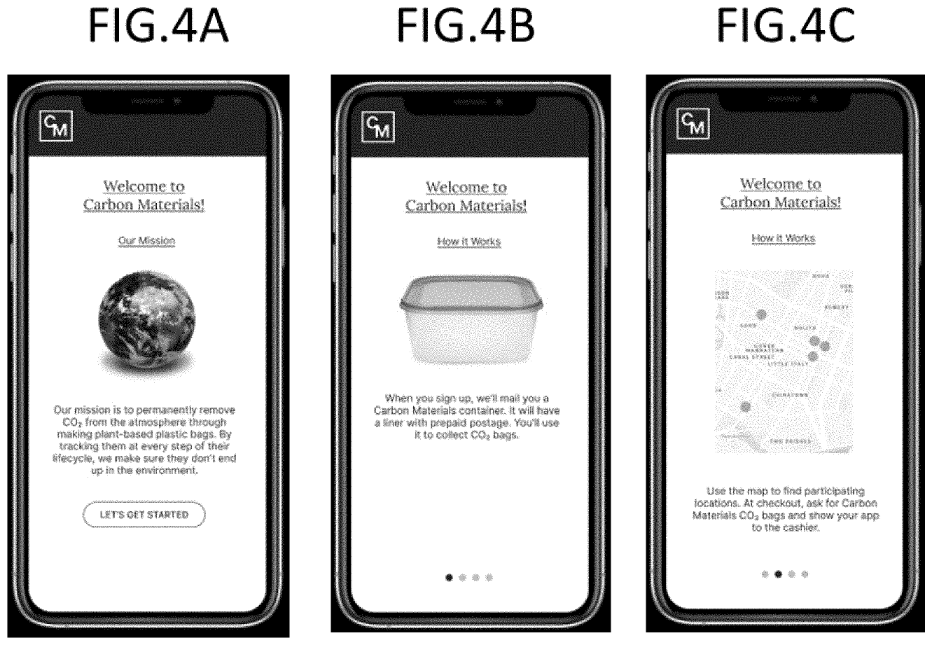

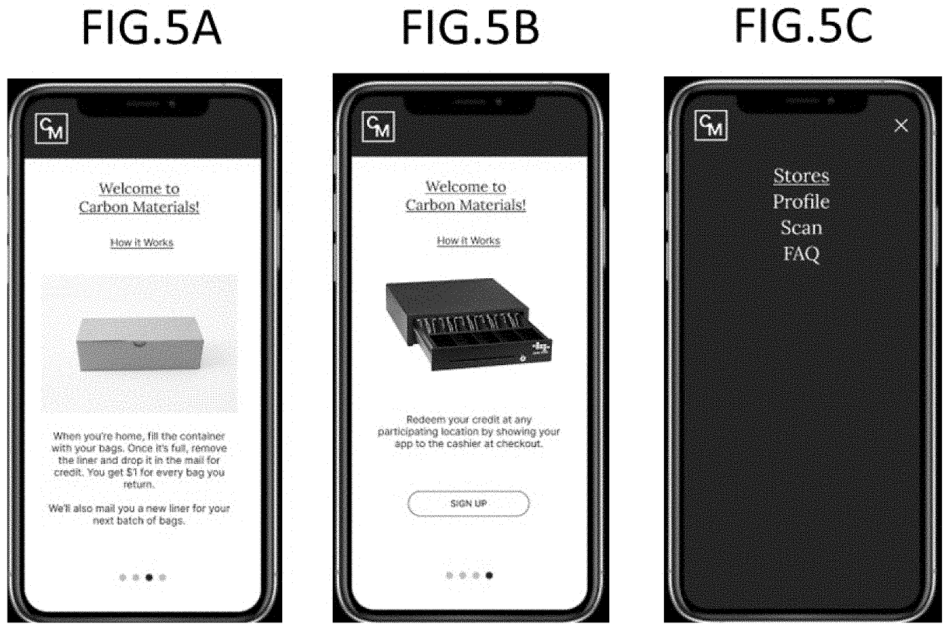

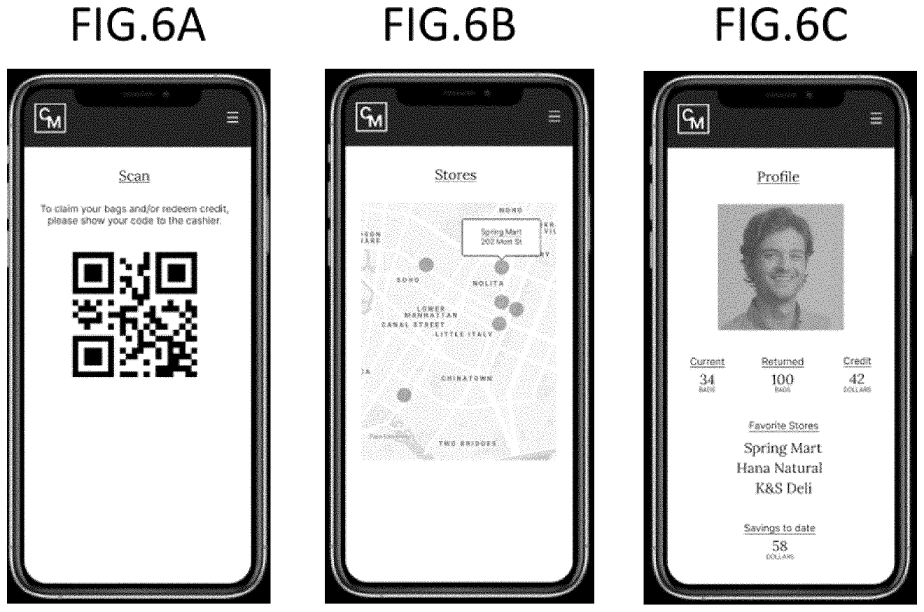

An example of the structure of the tracking system is presented in FIG. 3, a description follows. Plastics are created at the manufacturing facility, where a unique ID is generated for each unit, which is then printed with a QR code associated with said ID. The plastics are then either sold directly to the end consumer (1) or sold to a business customer (2). In the case where plastics are purchased by a business, the unique IDs for the purchased plastics are associated with a unique business ID in the database. If the plastic product is designed to be used by the business directly, the QR codes are scanned by employees following use, if possible, and the products are then discarded into a dedicated custom receptacle (6). If the plastic product is designed to be used by customers within a place of business, for example plastic utensils at a fast-food restaurant, customers may discard the items themselves in a custom receptacle located within the business (8). Businesses could schedule a pickup (10), during which drivers would weigh and scan the plastic to validate (12). Previously established pickup venues, such as but not limited to, USPS, could be utilized for pickup of the disposal custom receptacle. In the case of previously established pickup systems, the business is responsible for scanning and weighing of the disposal custom receptacle. In all cases, the disposal custom receptacle is transported to a dedicated facility, at which point the plastic would be either recycled or locked (17).

For products designed to be carried by the customer and/or kept at the customer's home, dedicated custom receptacles would be made available for the customers to have at home (13). Products designed to have a long lifetime within a customer's home would be marked as “kept” within the database (19) once scanned by the customer (11). This status would be periodically updated by the customer when prompted (20), with an incentive to keep the product for longer periods. Customers could schedule a pickup (14) in the same way as businesses, or in some cases ship the plastic back to the manufacturer once the products have reached the end of their useful life.

Unaccounted-for plastic would be marked as “Lost” within the database. Plastic discarded in the wrong custom receptacle, or plastic that was failed to be updated as “kept” (11) either initially or during a periodic prompt would become unaccounted-for after a pre-determined period of time. If the product was to then be found by the customer, the customer could scan the QR code for the product to regain its “kept” status within the database (16). Businesses could pay to have customers pick up untracked plastic from the environment to make up for “Lost” plastic, which would be picked up in the same way as in other cases (24).

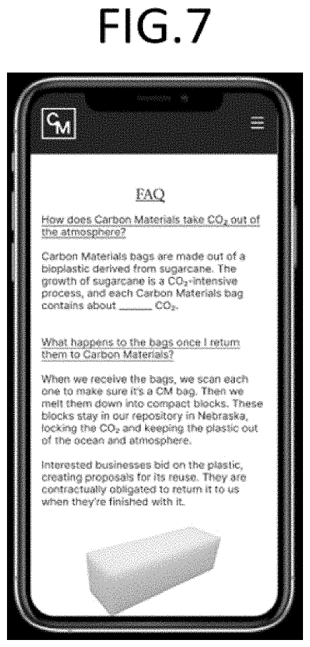

An example of the individual screens of a tracking application in a smartphone is presented in FIG. 4A to FIG. 6C. FIG. 4A to FIG. 4C illustrate-the Welcome Screens to the user of the tracking system interphase on a smartphone indicating the greenhouse gas removal mechanism and how the tracking process works; it also indicates the use of the tracking system for shopping plastic bags that are provided by participating shopping stores. The instructions on the screen guide the user to participating shopping stores where the bags are used. FIG. 5A to FIG. 5C further guide the user to the process of collecting and tracking the fate of the bags in the system. FIG. 6A and FIG. 6B show a QR code screen providing instructions to the user on how to scan the code in the object to retrieve credits. The last screen, FIG. 6C, shows a profile of the user with a summary of the information in the database for said user regarding his participation in the process. FIG. 7 is a screen containing answers to frequently asked questions regarding the carbon capture mechanism and the tracking system associated.

Aspects of the method disclosed herein are not limited in application to the details set forth in the previous description or illustrated in the contained drawings. Aspects of the method disclosed herein are capable of being practiced or of being carried out in various ways. Also, the phraseology and terminology used herein is for the purpose of description and should not be regarded as limiting. The use of “including,” “comprising,” “having,” “containing,” “involving,” and variations thereof herein is meant to encompass the items listed thereafter and equivalents thereof as well as additional items.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method for sequestering carbon from the atmosphere the method comprising the steps:
a) making consumer products from non-biodegradable biomaterial, and
c) collecting said consumer products after consumer use, and
d) managing said consumer products after collection, during reuse, recycle and final disposal, in such a way that 50% to 100% of the carbon in the product remains in the product and does not escape back as a gas to the atmosphere.

2. A method for sequestering carbon from the atmosphere the method comprising the steps:
a) making consumer products from a biomaterial, such as but not limited to a biopolymer, wood or bioplastics, and
b) collecting said consumer products after consumer use, and
c)) managing said consumer products after collection, during reuse, recycle and final disposal, in such a way that 50% to 100% of the carbon in the product remains in the product and does not escape back as a gas to the atmosphere.

3. The method of claim 2 where the degradation of the products is stopped by means such as but not limited to encapsulation, blending with an ingredient that inhibits biodegradation or material combination.

4. The method of claim 2 where the product degradation is stopped by storing the product or its materials in an environment that is not conducive to biodegradation.

5. A method for sequestering carbon from the atmosphere the method comprising the steps:
a) collecting consumer products made from a biomaterial after consumer use, and
b) managing said consumer products after collection, during reuse, recycle and final disposal, in such a way that 50% to 100% of the carbon in the product remains in the product and does not escape back as a gas to the atmosphere.

6. The method of claim 5 where the degradation of the products is stopped by means such as but not limited to encapsulation, blending with an ingredient that inhibits biodegradation or material combination.

7. The method of claim 5 where the product degradation is stopped by storing the product in an environment that is not conducive to biodegradation.

8. The method of claim 1 where the consumer product has a unique identifier and the fate of the product is tracked using a system such as but not limited to blockchain, in combination with said unique identifier during manufacturing, use, collection, and, managing after collection.

9. The method of claim 8 where the unique identifier is scanned, optically, electronically or by other means, and information such as but not limited to user, location and time is stored and/or updated in a database.

10. The method of claim 9 where the information in the database is used to calculate various metrics such as but not limited to greenhouse gas footprint, energy footprint or collection efficiency.

11. The method of claim 2 where the consumer product has a unique identifier and the fate of the product is tracked using a system such as but not limited to blockchain, in combination with said unique identifier during manufacturing, use, collection, and, managing after collection.

12. The method of claim 11 where the unique identifier is scanned, optically, electronically or by other means, and information such as but not limited to user, location and time is stored and/or updated in a database.

13. The method of claim 12 where the information in the database is used to calculate various metrics such as but not limited to carbon footprint, energy footprint or collection efficiency.

14. The method of claim 5 where the collected consumer product has a unique identification and the fate of the product is tracked using a system such as but not limited to blockchain, using said identification during managing after collection.

15. The method of claim 14 where the unique identification is scanned, optically, electronically or by other means, and information such as but not limited to user, location and time is stored and/or updated in a database.

16. The method of claim 15 where the information in the database is used to calculate various metrics such as but not limited to carbon footprint, energy footprint or collection efficiency.

17. The method of claim 1 where a custom receptacle is used for collecting the consumer products such as but not limited to straws or plastic bags.

18. The method of claim 2 where a custom receptacle is used for collecting the consumer products such as but not limited to straws or plastic bags.

19. The method of claim 5 where a custom receptacle is used for collecting the consumer products such as but not limited to straws or plastic bags.

20. A system for tracking the fate of consumers products made from biomaterials through its lifecycle including a unique ID code that it is assigned to the consumer product, means for scanning said ID code, a computer or a network of computers with ability to communicate information among them, means for transferring the scanned ID code information to said computer or computer network, a data base to store the information associated to said ID code in said computer or computer network, means to populate said database with information about the ID code, a software program with the ability to retrieve and process information associated to the ID code in the database.

21. The system of claim 21 where the computer or computer network is connected to the internet and can be accessed via computer devices, such as but not limited to mobile phones, laptops, tablets or desktop computers, and information related to the unique ID can be transferred to the database via said computer devices, or information from the data base or processed by the software program is retrieved by said computer devices.

22. The system of claim 21 where the database also includes features to track the use of the tracking mechanism by an individual user of the system and where said user supplies and retrieves information to and from the database or information processed by the software program.
